(19) United States
(12) Patent Application Publication
(10) Pub. No.: US 2010/0116078 A1
(43) Pub. Date: May 13, 2010

(54) Electrical connecting device of joint unit and robot having the same

(75) Inventor: Won Kuk Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/588,091

(22) Filed: Oct. 2, 2009

(30) Foreign Application Priority Data
Nov. 12, 2008 (KR) 10-2008-111945

(51) Int. Cl. B25J 17/00; H01R 39/00

(52) U.S. Cl. 74/490.02; 439/13

(57) ABSTRACT

Disclosed is an electrical connecting device of a joint unit. The electrical connecting device includes a first conductor provided at one side of the electrical connecting device and a second conductor provided at the other side of the electrical connecting device. The first and second conductors make contact with each other. Therefore, the joint unit is electrically connected at all times so that the joint unit is used as a module.

### CROSS-REFERENCE TO RELATED APPLICATIONS

This application claims the priority benefit of Korean Patent Application No. 10-2008-0111945, filed on Nov. 12, 2008, in the Korean Intellectual Property Office, the disclosure of which is incorporated herein by reference.

### BACKGROUND

1. Field

Embodiments relate to a robot joint. More particularly, embodiments relate to a robot joint having an electricity connecting device.

2. Description of the Related Art

A robot has joints to perform a mechanical motion. For example, a robot arm includes an upper arm part, a forearm part, and an elbow joint. The upper arm and forearm parts are folded or unfolded by the elbow joint.

The robot includes an electric system to operate a required function. The electric system includes numerous harnesses to operate the robot. Here, the harnesses may include an electric power line, a communication line, a sensor line, etc. These harnesses are installed in the robot. In general, most harnesses are installed in the robot while passing through the robot joint.

Particularly, in the case of the harnesses passing through the robot joint, the harnesses must have a length margin to ensure a mobile angle of the robot joint when the robot joint moves. For example, in the case of a robot arm, an upper arm part and a forearm part are folded or unfolded according to the operation of an elbow joint. At this time, the harness, which passes through the elbow joint, must have the length margin in order to facilitate the motion of the elbow joint.

However, if the harness is provided in the robot joint with the length margin, the harnesses may be entangled when the robot joint operates so that the harnesses may be broken down. If the harnesses are broken down, the electric system may not normally operate.

### SUMMARY

Accordingly, it is an aspect of exemplary embodiments to provide an electrical connecting device of a joint unit, capable of ensuring a mobile angle of a robot joint.

It is another aspect of exemplary embodiments to provide an electrical connecting device of a joint unit, capable of enabling a robot to normally perform functions thereof.

In accordance with an aspect of exemplary embodiments, there is provided an electrical connecting device of a joint unit including a first link, a second link rotatably coupled to the first link, a first conductor provided at the first link, and a second conductor provided at the second link to make contact with the first conductor.

At least one of the first conductor and the second conductor may have an arc shape having a constant radius about a rotational center of the second link.

The first and second conductors may have arc shapes having a constant radius about the rotational center of the second link.

The second conductor may slide on the first conductor as the second link rotates.

The first and second conductors may be press-fitted to each other.

The first conductor may include a receptacle and the second conductor may include a protrusion so that the protrusion is inserted into the receptacle.

The electrical connecting device may include a first electric cable provided at the first link and connected to the first conductor, and a second electric cable provided at the second link and connected to the second conductor.

According to another as aspect of exemplary embodiments, there is provided a robot including a first link, a second link, and a joint unit connecting the first link to the second link and including a first joint part fixed at one side of the first link, and a second joint part fixed at one side of the second link and rotatably coupled to the first joint part, wherein first and second conductors are provided between the first and second joint parts to make contact with each other such that the first and second conductors are electrically connected to each other.

The second conductor may slide on the first conductor as the second joint part rotates.

The first conductor may be provided at the first joint part, the second conductor may be provided at the second joint part, the first conductor may be connected to a first electric cable provided at the fist link, and the second conductor may be connected to a second electric cable provided at the second link.

As described above, according to the electrical connecting device of the joint unit of exemplary embodiments, the mobile angle of the joint unit can be increased by allowing two conductors to be electrically connected to the joint unit.

In addition, by removing the electric cables from the joint unit, problems caused by the electric cables, such as breakage of the electric cables, can be prevented so that the robot can normally perform all functions thereof, thereby improving reliability of the electric system.

In addition, the joint unit may be configured to be electrically connected at all time, so that the joint unit can be used in the form of a module.

### BRIEF DESCRIPTION OF THE DRAWINGS

These and/or other aspects of exemplary embodiments will become apparent and more readily appreciated from the following description of exemplary embodiments, taken in conjunction with the accompanying drawings of which:

FIG. 1 is a perspective view showing a robot leg according to an exemplary embodiment;

FIG. 2 is a sectional view showing a knee joint unit of the robot leg according to an exemplary embodiment;

FIG. 3 is an exploded perspective view showing a knee joint unit according to an exemplary embodiment;

FIGS. 4 and 5 are schematic views showing the operation of a knee joint unit according to an exemplary embodiment; and

FIG. 6 is a perspective view showing first and second conductors of an electrical connecting device according to another exemplary embodiment.

### DETAILED DESCRIPTION

Reference will now be made in detail to exemplary embodiments, examples of which are illustrated in the accompanying drawings, wherein like reference numerals refer to the like elements throughout.

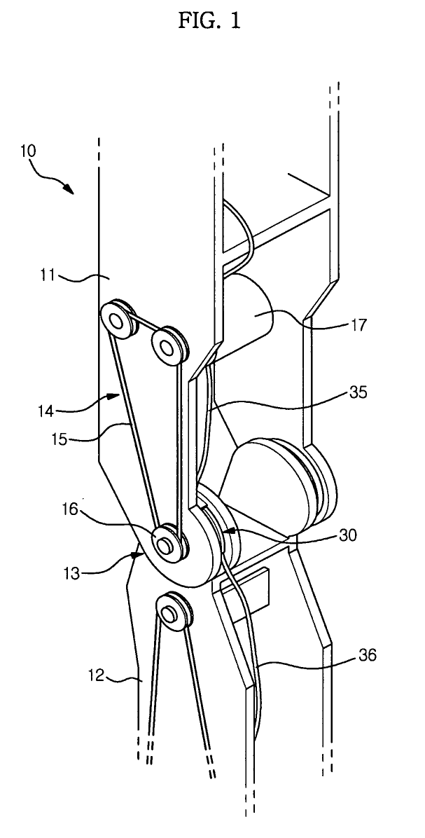

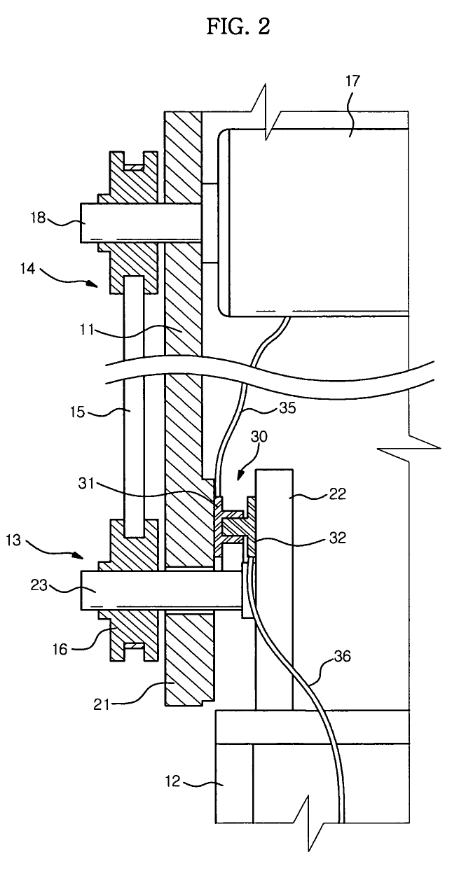

FIG. 1 is a perspective view showing a robot leg according to an exemplary embodiment, and FIG. 2 is a sectional view showing a knee joint unit of the robot leg according to an exemplary embodiment.

As shown in FIGS. 1 and 2, a robot leg 10 according to an exemplary embodiment includes a femoral part 11, a lower leg part 12, and a knee joint unit 13. As the knee joint unit 13 is driven, the femoral part 11 and the lower leg part 12 are folded or unfolded.

The robot leg 10 includes a motor 17, which provides power to the knee joint unit 13. The motor 17 is installed in the femoral part 11 to provide power to the knee joint unit 13 through a power transmission device 14.

The power transmission device 14 connects the motor 17 to the knee joint unit 13. In detail, the power transmission device 14 connects a driving shaft 18 of the motor 17 to a rotation shaft 23 of the knee joint unit 13. Therefore, as the driving shaft 18 of the motor 17 rotates, the rotation shaft 23 of the knee joint unit 13 also rotates by the power transmission device 14. FIG. 1 shows the power transmission device 14 including a belt 15 and a pulley 16. The power transmission device 14 may also include a gear.

The knee joint unit 13 includes a rotation shaft 23. The rotation shaft 23 can be integrally formed with the lower leg part 12 or can be fixed to the lower leg part 12 as a separate member.

Driving force of the motor 17 is transferred to the rotation shaft 23 of the knee joint unit 13 by the power transmission device 14, so that the rotation shaft 23 can rotate. As the rotation shaft 23 rotates, the lower leg part 12 can rotate together with the rotation shaft 23. Therefore, the lower leg part 12 rotates relative to the femoral part 11, so that the lower leg part 12 and the femoral part 11 can be folded or unfolded.

The robot leg 10 includes an electric system to perform a required function. The electric system includes electric cables 35 and 36 capable of transmitting electric power, electric signal, etc. These electric cables 35 and 36 are installed in the robot leg 10. For example, as shown in FIGS. 1 and 2, the first electric cable 35 is installed in the femoral part 11 and the second electric cable 36 is installed in the lower leg part 12. The first and second electric cables 35 and 36 are connected with each other by an electric connecting device 30, which is provided in the knee joint unit 13.

If the first and second electric cables 35 and 36 are connected with each other at the knee joint unit 13 by the electric connecting device 30, the mobile angle of the joint unit can be sufficiently ensured. Hereinafter, this will be described in detail.

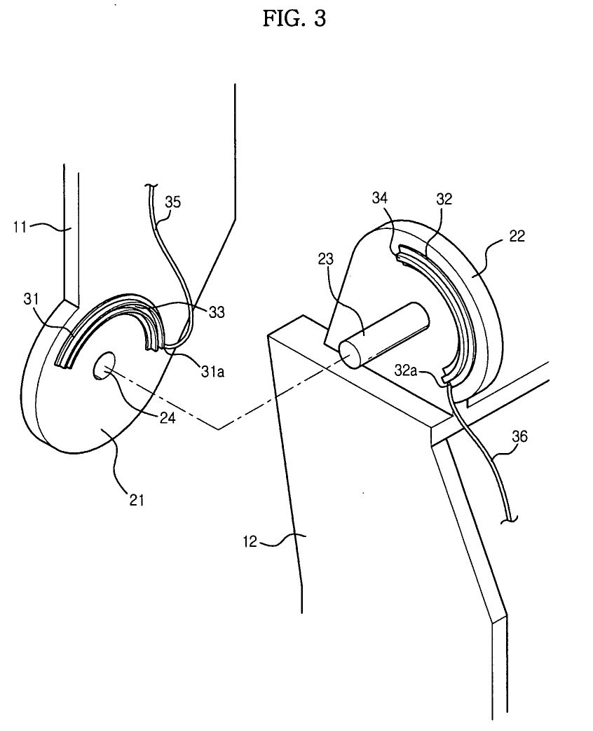

FIG. 3 is an exploded perspective view showing a knee joint unit according to an exemplary embodiment.

As shown in FIGS. 2 and 3, the knee joint unit 13 according to an exemplary embodiment includes a first joint part 21 provided at one side of the femoral part 11 and a second joint part 22 provided at one side of the lower leg part 12. The first and second joint parts 21 and 22 are coupled to each other by a shaft. That is, a rotation shaft 23 of the second joint part 22 is rotatably inserted into a groove 24 of the first joint part 21. The rotation shaft 23 rotates together with the second joint part 22. As described above, the rotation shaft 23 can be integrally formed with the second joint part 22 or can be fixed to the second joint part 22 as a separate member.

The knee joint unit 13 includes an electric connecting device 30 for electrically connecting the first joint part 21 and the second joint part 22, which are relatively rotating. The electric connecting device 30 includes a first conductor 31 provided at the first joint part 21 and a second conductor 32 provided at the second joint part 22. As shown in FIG. 2, the first and second conductors 31 and 32 are in contact with each other in such a manner that they can be electrically connected at all time.

In addition, the knee joint unit 13 may include an absolute encoder or a torque sensor in order to transmit a detecting signal corresponding to rotation angle thereof. The knee joint unit 13 may also include a sensor, such as a mechanical stopper or a photo limit switch, to prevent the knee joint unit 13 from excessively moving beyond the mobile angle.

The first conductor 31 has an arc shape having the constant radius about the rotation shaft 23 and the second conductor 32 has an arc shape having the constant radius about the rotation shaft 23. The first and second conductors 31 and 32 are press-fitted to each other such that a protrusion 34 of the second conductor 32 can be inserted into a receptacle 33 of the first conductor 31. According to these shape and structure, if the second joint part 22 rotates, the second conductor 32 slides on the first conductor 31 and the first and second conductors 31 and 32 are in contact with each other in such a manner that they can be electrically connected at all time. In contrast, although not shown in drawings, the first conductor 31 can be provided with a protrusion and the second conductor 32 can be provided with a receptacle in such a manner that the protrusion of the first conductor 31 can be inserted into the receptacle of the second conductor 32.

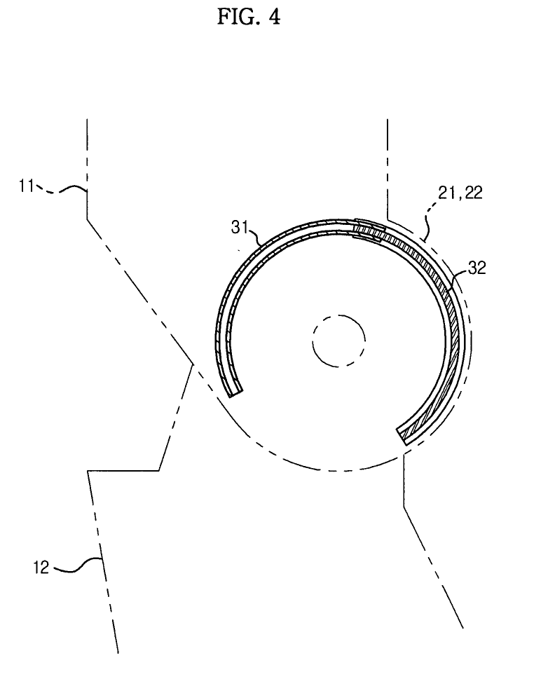

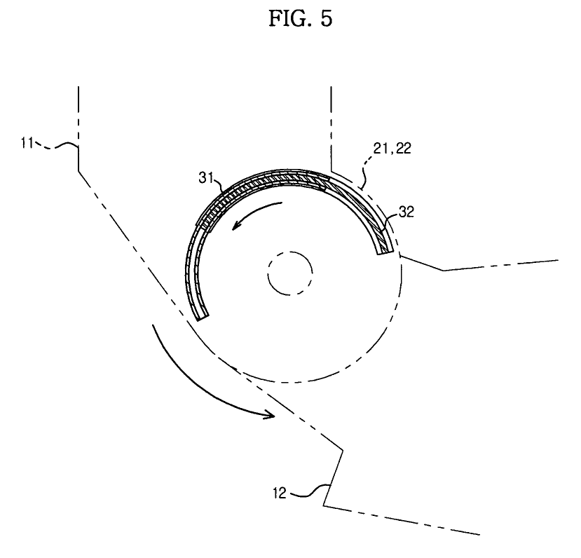

FIGS. 4 and 5 are schematic views showing the operation of the knee joint unit according to an exemplary embodiment.

As shown in FIGS. 4 and 5, according to the knee joint unit 13 of exemplary embodiments, the femoral part 11 and the lower leg part 12 of the robot leg 10 are unfolded at the initial state as shown in FIG. 4. Meanwhile, the femoral part 11 and the lower leg part 12 of the robot leg 10 are folded at the operation state as shown in FIG. 5. Here, the operation state refers to a state that the knee joint unit 13 is operated by a motor 17 to rotate the second joint part 22 (or lower leg part 12) by a certain degree.

In the initial state of the knee joint unit 13, a right part of the first conductor 31 overlaps a left part of the second conductor 32. However, in an operation state of the knee joint unit 13, the first conductor 31 completely overlaps the second conductor 32 as the second conductor 32 slides on the first conductor 31. As described above, the first and second conductors 31 and 32 are in contact with each other in such a manner that they can be electrically connected at all time. Thus, if the arc shapes of the first and second conductors 31 and 32 are larger, the mobile angle of the knee joint unit 13 can be sufficiently increased. That is, the rotation angle of the second joint part 22 can be increased.

In addition, since the first and second conductors 31 and 32 are not easily broken down, they can perform all functions of the robot. Referring to FIG. 3, the first electric cable 35 is connected to one end 31a of the first conductor 31 and the second electric cable 36 is connected to one end 32a of the second conductor 32. Since the first and second conductors 31 and 32 are in contact with each other at all time, the first electric cable 35, the first conductor 31, the second conductor 32, and the second electric cable 36 can be electrically connected with each other. Since the first electric cable 35 rotates together with the first joint part 21, the margin of the first electric cable 35 is not required. Since the second electric cable 36 also rotates together with the second joint part 22, the margin of the second electric cable 36 is not required. Thus, the problem occurring in the prior art, in which the margin of the electric cable installed between the first joint part 21 and the second joint part 22 is broken down, can be prevented.

Meanwhile, the knee joint unit 13 can be used in the form of a module. That is, in order to connect the femoral part 11 to the lower leg part 12, the first joint part 21 of the knee joint unit 13 is coupled with the femoral part 11 and the second joint part 22 of the knee joint unit 13 is coupled with the lower leg part 12. Thereafter, when the first electric cable 35 is connected to the first conductor 31 and the second electric cable 36 is connected to the second conductor 32, the electric system can perform all functions thereof.

The above-mentioned joint unit can be formed into a module and then applied to the numerous joints of the robot. For example, if an upper arm part of the robot is a first link and a lower leg part of the robot is a second link, the first link and the second link can be connected using the modulized joint unit.

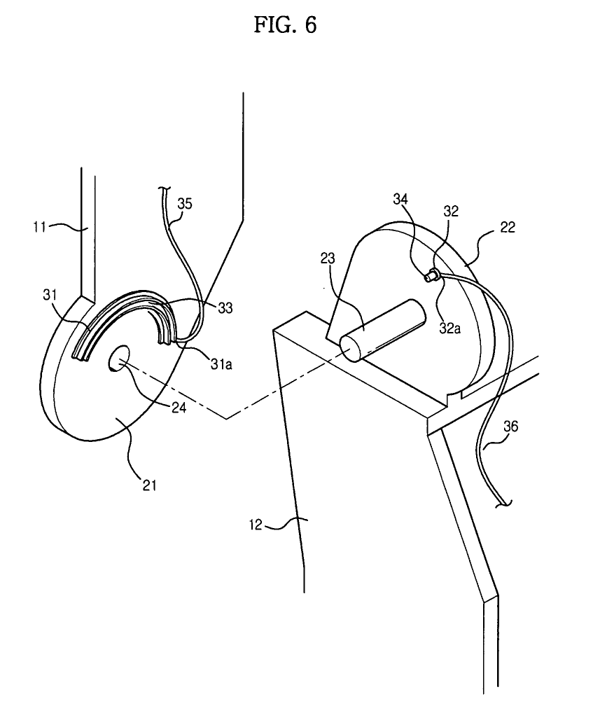

FIG. 6 is a perspective view showing first and second conductors of an electrical connecting device according to another exemplary embodiment.

As shown in FIG. 6, according to another exemplary embodiment, the first conductor 31 has an arc shape having the constant radius about a rotation shaft 23 and the second conductor 32 has a protrusion shape adapted to make contact with the first conductor 31.

The first and second conductors 31 and 32 are press-fitted to each other in such a manner that a protrusion 34 of the second conductor 32 can be inserted into a receptacle 33 of the first conductor 31. Accordingly, if the second joint part 22 rotates, the second conductor 32 not only slides on the first conductor 31, but also keeps the electric contact with the first conductor 31, continuously.

Therefore, if the arc shape of the first conductor 31 becomes larger, the sliding distance of the second conductor 32 can be increased. This means that the rotation angle of the second joint part 22 or the mobile angle of the knee joint unit 13 can be increased.

The first and second conductors 31 and 32 may have various shapes in addition to the shapes shown in FIGS. 3 and 6. That is, the first and second conductors 31 and 32 may have various shapes if the first and second conductors 31 and 32 can make contact with each other during the rotation of the second joint part 22 (or lower leg part 12).

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An electrical connecting device of a joint unit comprising:
a first link;
a second link rotatably coupled to the first link;
a first conductor provided at the first link; and
a second conductor provided at the second link to make contact with the first conductor.

2. The electrical connecting device of a joint unit of claim 1, wherein at least one of the first conductor and the second conductor has an arc shape having a constant radius about a rotational center of the second link.

3. The electrical connecting device of a joint unit of claim 1, wherein the first and second conductors have arc shapes having a constant radius about the rotational center of the second link.

4. The electrical connecting device of a joint unit of claim 1, wherein the second conductor slides on the first conductor as the second link rotates.

5. The electrical connecting device of a joint unit of claim 1, wherein the first and second conductors are press-fitted to each other.

6. The electrical connecting device of a joint unit of claim 5, wherein the first conductor includes a receptacle and the second conductor includes a protrusion so that the protrusion is inserted into the receptacle.

7. The electrical connecting device of a joint unit of claim 1, further comprising a first electric cable provided at the first link and connected to the first conductor, and a second electric cable provided at the second link and connected to the second conductor.

8. A robot comprising:
a first link;
a second link; and
a joint unit to connect the first link to the second link, the joint unit including a first joint part fixed at one side of the first link, and a second joint part fixed at one side of the second link and rotatably coupled to the first joint part,
wherein first and second conductors are provided between the first and second joint parts to make contact with each other such that the first and second conductors are electrically connected to each other.

9. The robot of claim 8, wherein the second conductor slides on the first conductor as the second joint part rotates.

10. The robot of claim 8, wherein the first conductor is provided at the first joint part, the second conductor is provided at the second joint part, the first conductor is connected to a first electric cable provided at the fist link, and the second conductor is connected to a second electric cable provided at the second link.
